(19) United States
(12) Patent Application Publication
(10) Pub. No.: US 2005/0234620 A1
(43) Pub. Date: Oct. 20, 2005

(54) Method for controlling and adjusting digitally or analogically adjustable shock absorbers

(75) Inventors: Georg Roll, Heusenstamm (DE); Steffen Troster, Liederbach (DE)

Correspondence Address: Gerlinde Nattler;Continental Teves Inc, One Continental Drive, Auburn Hills, MI, 48326, US

(73) Assignee: Continental Teves AG & Co. oHG, Frank am Main (DE)

(21) Appl. No.: 10/526,517

(22) PCT Filed: Sep. 4, 2003
(86) PCT No.: PCT/EP03/09838

§ 371 Date: Mar. 3, 2005

(30) Foreign Application Priority Data
Sep. 5, 2002 (DE) 102 41 012.7

(51) Int. Cl. B62C 3/00

(52) U.S. Cl. 701/37

(57) ABSTRACT

The invention relates to a method for controlling and adjusting digitally or analogically adjustable shock absorbers, preferably in a two-axle road vehicle where the shock absorbers are controlled according to the situation by means of a control signal such that the road performance of the vehicle is improved when understeering or oversteering occurs. To improve the dynamics of movement of a vehicle in any driving situation, it is proposed according to the invention, to determine phase magnitudes, from which the phases of the control signals is calculated, and, in the case of a driving situation with a tendency to sway, to determine a moment in time, as a function of at least the magnitudes which describe the rotation of the vehicle about the vertical axis, when a correct phase control of the shock absorbers of the vehicle is carried out to increase the steerability when understeering occurs and to increase the driving stability when oversteering occurs.

### BACKGROUND OF THE INVENTION

The invention relates to a method for controlling and adjusting digitally or analogically adjustable shock absorbers, preferably in a two-axle road vehicle where the shock absorbers are controlled according to the situation by means of a control signal such that the road performance of the vehicle is improved when understeering or oversteering occurs.

Conventional ESP systems influence the horizontal dynamics of vehicles by a targeted active buildup of brake pressure in individual wheels, for the purpose of thereby decreasing additional yaw moments about the vehicle's vertical axis, and to maintain the vehicle, with regard to yaw rate and optionally swaying angle, at predetermined desired values, which are determined by vehicle model calculations (DE 195 15 048 A1). An additional known mechanism of ESP systems consists in reducing the motor moment requested by the driver, for the purpose of preferably suppressing strong understeering to low friction values. In both cases, the dynamics of the vehicle are in part considerably reduced, which leads to a change in the vehicle characteristic. Particularly in vehicles designed for high dynamics, the driver experiences this as a changed or more difficult handling.

Therefore, it would be desirable to influence the horizontal dynamics of a vehicle by changing the characteristic of the vertical behavior. This can be achieved by a dynamic change of the shock absorber characteristic by means of adjustable shock absorbers.

In DE 198 03 370 A1, the spring and/or damping device is locked to prevent an upswing effect of the vehicle frame or the body, which occasionally occurs in extreme driving situations. In addition, in DE 40 19 732 A1, it is proposed to lock the damping device in the case of a defined transverse acceleration and thus to support the curve shift of the spring-mounted masses.

In addition, it is known that shock absorbers which are switched to hard at the front axle lead to understeering of the vehicle, while rear axle shock absorbers which are switched to hard promote oversteering of the vehicle. These effects are achieved by the available total lateral force of each axle. The total lateral force decreases in the case of the start of dynamic swaying of the vehicle in the case of hard damping, while, in the case of soft damping, the total lateral force is increased slightly compared to the neutral state of the shock absorber.

The present invention is therefore based on the problem of improving the dynamics of movement of a vehicle in any driving maneuvers.

In addition, the purpose of the method and the device according to the invention consists in presenting strategies, which provide for an early adjustment of the shock absorbers, which also optimally supports highly dynamic driving maneuvers and above all critically combination maneuvers (changing lanes, etc.).

### SUMMARY OF THE INVENTION

The problem is solved according to the invention by determining the phase magnitudes, from which the phases of the control signals are calculated, and by the fact that, in the case of a driving situation with a tendency to sway, a moment in time is determined, as a function of at least the magnitudes which describe the rotation of the vehicle about the vertical axis, when a correct phase control of the shock absorbers of the vehicle is carried out to increase the steerability when understeering occurs and to increase the driving stability when oversteering occurs.

In the case of a driving situation with tendency to sway, the beginning of swaying or expected swaying in the future can be recognized.

The dynamics of movement of a vehicle are here improved in any driving maneuvers, by adjusting the characteristic of the shock absorber highly dynamically as a function of the yaw raw and the yaw acceleration, so that the vehicle follows a reference yaw rate which is calculated by the ESP system, without the need, in the ideal case, of actively using the conventional ESP with brake and motor interventions.

Here, as a result of the variation of the available total lateral forces of the front and rear axles, the vehicle characteristic is varied dynamically as a function of different driving states and situations. It follows therefrom that the vehicle is imparted a tendency to an understeering or oversteering behavior, which is superposed over the mechanically conditioned basic design of the vehicle. In practice, it has been shown that the effects of such a variation can be used to advantage only if the shock absorber control is carried out as a function of the driving maneuver, which has occurred with a phase that is adapted absolutely to the course of the yaw rate and the yaw acceleration. Therefore, an integration of the shock absorber control in the ESP is advantageous, where the ESP system already has appropriate signals and vehicle models. The content of the patent DE 195 15 048 A1, which was mentioned in the introduction, will therefore also be a part of the present application, because DE 195 15 048 A1 describes the determination of the yaw rate, of the reference yaw rate and of the magnitudes of the dynamics of movement, as well as the ESP control strategy.

The method for controlling and adjusting digitally or analogically adjustable shock absorbers is preferably applied in a two-axle road vehicle, where the shock absorbers are controlled as a function of the situation in such a manner that, when understeering occurs, the steerability is increased, and when oversteering occurs, the driving stability is increased. For early detection, the deviation between a reference yaw rate which is determined according to the linear single-track model (DE 195 15 048 A1) and the actually measured yaw rate of the vehicle as well as the difference in the gradients of the two yaw rates, that is the reference yaw acceleration and the actual yaw acceleration of the vehicle, in order to define phase-accurate switching moments in time, between which the shock absorbers of two wheels are switched to hard or soft, in steps or continuously. Advantageously, the control concept is a part of a currently available ESP control strategy, which is optionally implemented in the control device of the ESP and uses the signals of the ESP system (therefore, the term ESP shock absorber control is used below for the concept, which has been presented here).

However, in the case of strong understeering or overdriving situations, it is possible to keep superposing, without changes, brake and motor actuations of the ESP control over actuations of the shock absorber control. As a result of the adaptive shock absorber control, the stability limit of the vehicle is thus shifted toward higher dynamics of movement.

Because the shock absorbers, in principle, present a finite adjustment time, the presented concept provides for integrating this adjustment time as a delay time in the control strategy, so that the required shock absorber characteristic is always present at the right moment in time.

Additional advantages and details can be obtained from the following description of embodiment examples.

### BRIEF DESCRIPTION OF THE DRAWINGS

The individual figures show:

FIG. 1 a simple basic strategy for shock absorber control, which works with phase accuracy in situations whose dynamics of movement are simple,

FIG. 2 an improved basic strategy, which leads to an improved phase accuracy of the shock absorber control,

FIG. 3 a strategy which has been extended, compared to FIG. 2, and which leads to an improved shock absorber control, especially with higher dynamics of movement,

FIG. 4 a further improved strategy, compared to FIG. 3, which, in some phases, leads to a vehicle-stabilizing shock absorber control at an even earlier moment in time.

FIG. 5, as an example of a road situation, a change of lane and the shock absorber control which is desired in each case according to the strategy of FIG. 4.

FIG. 6 the block diagram of an example of a device for carrying out the strategy of FIG. 4, which consists of a signal processing, a block to evaluate the dynamics of the driving maneuver, a block for the coordination and the overlaying of the strategy with other strategies (example: skyhook control), as well as a block which contains a automated status device for identifying the driving situation.

FIG. 7 a device for the calculation of the required signals.

FIG. 8 an example of a device for a proportional superpositioning of different shock absorber control strategies, where the requirement according to the concept, which has been presented here, is superposed over the requirement of a skyhook control strategy (which is not described here).

FIG. 9 an example of a device to carry out the block “temporal control with characteristic line field” of FIG. 6.

FIG. 10 the implementation of the automated status device of FIG. 6, which identifies the phases and driving statuses of the control strategy which is presented in FIG. 4, for a phase-accurate shock absorber control, and generates appropriate control signals.

### DETAILED DESCRIPTION OF THE DRAWINGS

The concept of shock absorber control is described in detail below.

Signals Used:

Using different signals, which in part are taken directly from the ESP and in part generated by the device, which is presented here, the behavior of the vehicle is evaluated.

The idea of the principle of the method consists in that the vehicle behavior is observed using yaw rates, but also their derivates with respect to time (gradients), that is yaw accelerations.

The reference yaw rate which is usually used in ESP systems, indicates the yaw rates which the driver would like to reach on the basis of his/her steering activity, and which can also be implemented in physical terms, taking into consideration the vehicle's own installed steering behavior and the existing road friction values, without the vehicle loosing its road stability. This reference yaw rate thus represents a direct desired value \dot{ψ}_{desired} for the ESP control and it is not optimally suited for the concept which is presented here.

The reference yaw rate which is need here is the yaw rate, which is based on the given steering angle, of the stationary single-track model, which, first of all, represents the driver's desired steering (without taking into consideration whether it can be carried out physically):

Calculation:

$${\dot{ψ}}_{ref} = δ \frac{v}{l + EG * {v}^{2}}$$

with
δ=steering angle at the wheel (is derived from the steering wheel angle),
ν=longitudinal vehicle speed (is evaluated in general from the wheel circumferential speeds),
l=wheel position
EG=vehicle's own steering gradient

This references yaw rate \dot{ψ}_{ref} indicates the maneuver which the driver intends to carry out, and, in terms of phase, it generally precedes \dot{ψ}_{desired} of the ESP control and the actual yaw rate \dot{ψ}.

Using this signal, one can now evaluate how strongly the vehicle will sway subsequently, where the assumption always is that the high friction value of μ is equal to 1. Because the reference yaw rate signal \dot{ψ}_{ref}, in terms of phase, precedes the vehicle reaction by much, sufficient time remains to simultaneously start the shock absorber control, with high signal dynamics (clear wish of the driver to change the direction), before the vehicle starts to sway or before its swaying behavior changes. This is important, because the shock absorber characteristic is always only effective if the spring action path at the wheel in question changes:
F=D*\dot{x}
with
D=shock absorber constant (is changed by adjustment)
x=spring action path
\dot{x}=spring action speed

As additional ESP signals, one uses the vehicle yaw rate \dot{ψ}, which is easily filtered and corroborated via plausibility, the vehicle acceleration a_{y} (for example in the center of gravity of the vehicle, at the front axle and/or at the rear axle), the steering angle at the wheel δ as well as the longitudinal vehicle speed ν.

Control Strategy:

The control strategy which is used, in principle, provided for making a decision, using the difference of the actual yaw rate \dot{ψ} and the reference yaw rate \dot{ψ}_{ref}, to determine whether the vehicle, in the time period considered or in the current control cycle, is in a neutral driving mode or whether understeering or oversteering occurs.

In the case of straight driving, stationary cornering (swaying angle nearly constant) as well as in the case of the start of neutral steering behavior (yaw rate difference \dot{ψ}_{ref}−\dot{ψ} small), all the shock absorbers are set in a neutral state, which corresponds either to the basic design of the vehicle or which is the result of another control strategy, for example one which is based on comfort (example: skyhook control).

If the vehicle has tendency to understeer (characterized in that the amount of \dot{ψ}_{ref} is greater than the amount of \dot{ψ}), the vehicle characteristic is switched to “oversteering behavior,” by switching the shock absorber of the front axle to soft and that of the rear axle to hard. As a result, the available total lateral force of the front axle is slightly increased and that of the rear axle is slightly decreased. Thus, during the a curve-dependent spring action, an increased steering moment builds up, which is supported more poorly by the rear axle than in the state with neutral setting, which would impart to the vehicle its own installed steering behavior. The physical effect of this measure consists in that the yaw rate of the vehicle is increased and thus approximates the driver's intention.

In the case of a recognized oversteering tendency of the vehicle (which is characterized in that the amount of \dot{ψ}_{ref} is smaller than the amount of \dot{ψ}), the vehicle characteristic is switched to “understeering behavior” by switching the shock absorber of the front axle to hard and that of the rear axle to soft. As a result, the available total lateral force of the front axle is slight decreased and that of the rear axle is slightly increased. During the curve-caused application and cessation of spring action, the steering moment is thus decreased and, in addition, it is better supported by the rear axle than in the state of neutral setting.

The physical effect of this measure is that the yaw rate of the vehicle decreases and thus approximates the driver's intention.

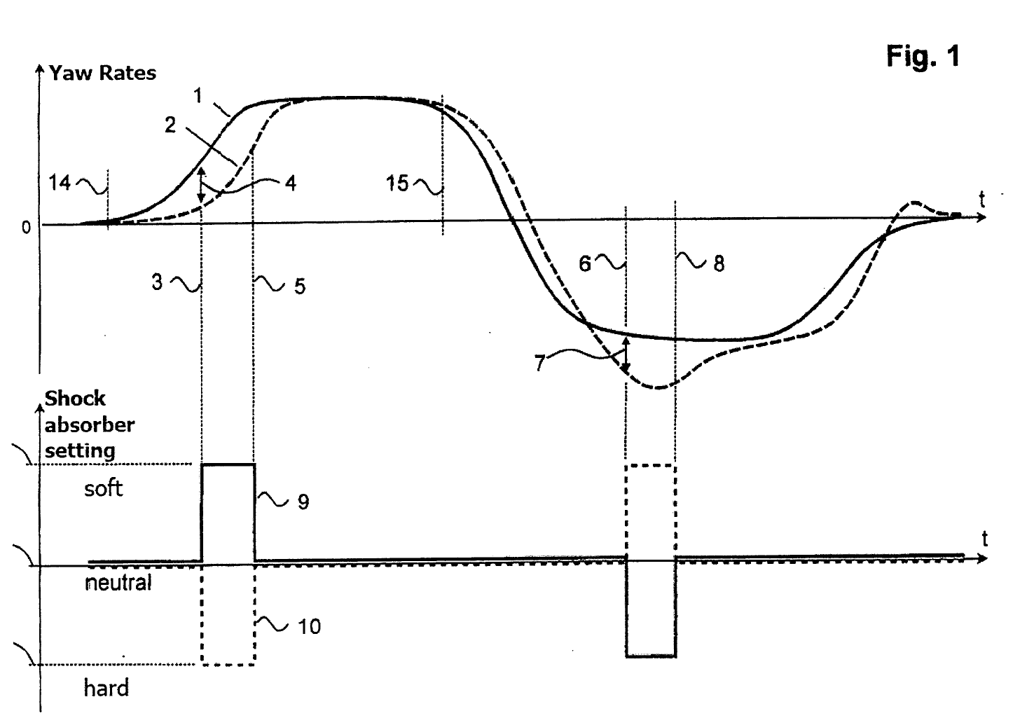

FIG. 1 represents this situation using an example and the temporal sequence which occurs when moving from a left to right curve.

Here 1 is the reference yaw rate \dot{ψ}_{ref}, which is indicated by the driver's intended steering angle, and signal 2 represents the actual (measured) vehicle yaw rate \dot{ψ}.

First, at time 14, the driver initiates a left curve (yaw rates 1 and 2 positive).

At time 3, the system recognizes an understeering tendency, because the reference yaw rate 1 is above the measured yaw rate 2 by a large amount 4. To improve the steerability of the vehicle, an attempt is made to force an oversteering behavior using the shock absorber control. For this purpose, the shock absorbers of the front axle (curve pattern 9) is switched at time 3 from the neutral state 12 to the soft state 11, while the rear axle shock absorbers (curve pattern 10) are changed from the neutral state 12 to the hard state 13.

At time 5, the yaw rate 2 has approximated the reference yaw rate 1 so closely that all the shock absorbers are switched again to their neutral state 12 (at time 15, the driver starts to steer from the left curve into the right curve (yaw rates 1 and 2 then become negative).

At time 6, the vehicle presents an oversteering tendency with respect to the new right steering, which is characterized by the clear (in terms of amount) excess swaying 7 of the yaw rate 2 above the reference yaw rate 1 in the time interval 6 to 8.

Therefore, the shock absorbers are again switched individually in this time interval from the neutral state 12. To suppress oversteering, the vehicle is now forced into an understeering behavior, by switching the shock absorbers of the front axle from neutral 12 to part 13, and the shock absorbers of the rear axle from neutral 12 to soft 11.

In practice, it has been shown that good results can be achieved with this strategy in many driving situations. However, in the example of FIG. 1, a major problem arises. If the shock absorber switching occurs at time 6, the swaying of the vehicle to a large extent is already in the new curve direction, so that the shock absorber readjustment can achieve only minimal effect.

Therefore, an additional strategy is provided, which allows an earlier readjustment of the shock absorbers, and which also optimally supports highly dynamic maneuvers and above all critical composite maneuvers (changing lanes, etc.).

This can no longer be achieved alone by considering the deviations between the reference yaw rate 1 and actual rate 2. Rather, an important criterion is the gradient of the vehicle yaw rate, that is the yaw acceleration of the vehicle, particularly when the yaw rate passes through a zero point, when a curve change occurs, or in a band around this zero point.

Furthermore, one must take into account what the amount of the yaw rate was before its zero pass, how the previous curve was steered dynamically, and how rapidly the change in steering into the new curve direction occurred. In addition, the decisive factor is for how long the previous curve direction (before the zero pass) was driven in. The latter factor determines whether the vehicle was able to stabilize sufficiently in the previous curve direction. In the case of short time intervals for one curve direction, one must start with a highly dynamic maneuver. During such a maneuver, an attempt must be made after each curve change to confer as much stability to the vehicle as possible, which is achieved by an early adjustment of a soft shock absorber characteristic at the back wheels.

Therefore, an additional method for adjusting the shock absorbers provides for a shock absorber control which—in contrast to the conventional ESP control—considers not only the deviation in adjustment between the reference and the actual yaw rate as criterion for an intervention, but also the course of the yaw rate itself, where the absolute maximum of the yaw rate as well as the yaw acceleration are used particularly in the zero pass of the yaw rate.

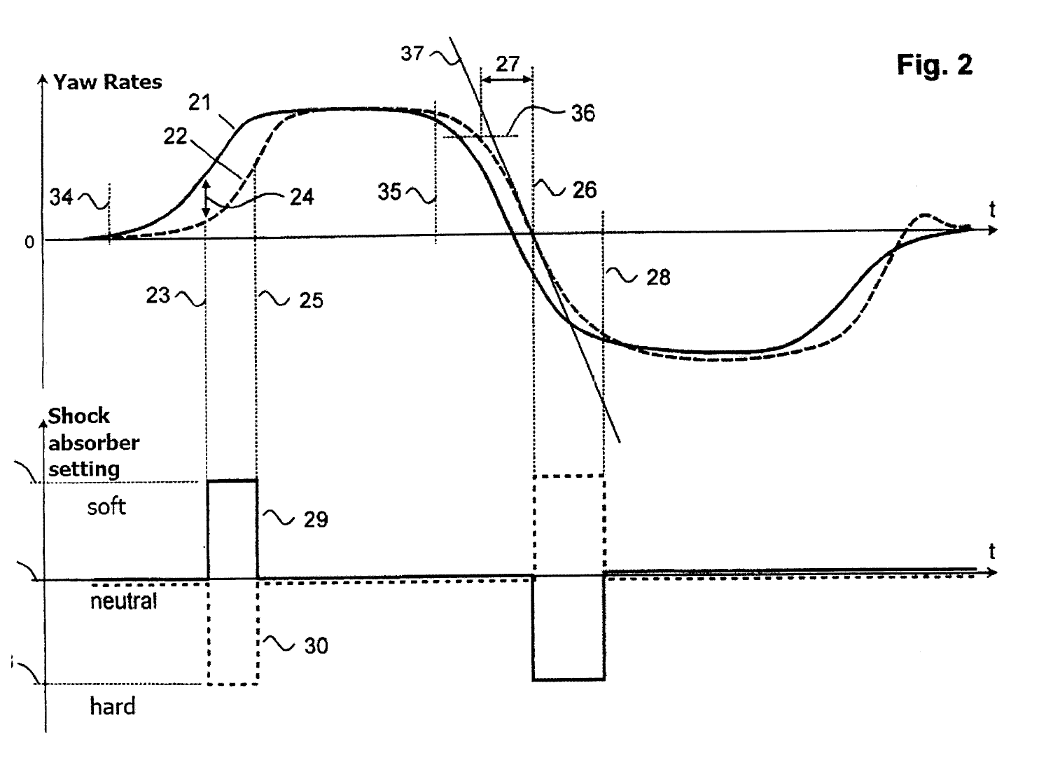

On this topic, FIG. 2 shows an example of a steering maneuver which is similar to that of FIG. 1.

At time 34, the driver steers into a left curve and, at timer 35, he/she starts with a countersteering into the right curve. In the process, immediately after the countersteering in 35 as a function of the gradient 37 of the vehicle yaw rate 22 in its zero pass at time 26, a shock absorber characteristic is immediately adjusted, which confers an understeering tendency to the vehicle, in spite of the fact that the vehicle has not yet turned into the required right direction. Accordingly, at time 26, the shock absorbers of the front axle (course 29) are switched to hard, and those of the rear axle (course 30) are switched to soft. In the represented example, the result is that the started swaying curve condition is reached at the time 28, without the yaw rate 22 swaying above the reference 21. The vehicle, as a result of the prophylactic (preventive) measure at time 26, remains more stable at time 26 than if the measure is taken at time 6 as in FIG. 1. This means that the tendency to sway of the vehicle is determined using the magnitudes of the yaw acceleration at a time when the vehicle has not yet started swaying.

To avoid removing too much dynamics from the vehicle in uncritical cases during countersteering, the described intervention at time 26 occurs only when the amount of the yaw acceleration in the zero pass of the yaw rate exceeds a determined threshold value:
|\ddot{ψ}|>threshold

For the threshold, a fixed value, for example, 100 degree/s*s, can be used as empirical value. According to other embodiment examples, this threshold is also calculated as a function of the vehicle speed and/or the maximum yaw rate achieved immediately before (for example in a defined time interval leave ΔT 27), as well as other magnitudes which are relevant to the dynamics of movement, for example using the following relation:
Threshold=f(v(vehicle), \dot{ψ}ₘₐₓ(ΔT), \ddot{ψ}ₘₐₓ(ΔT), a_{y,max}(ΔT))

Here the Following Principle of Relation Exists:

If the vehicle speeds are low, a higher threshold is required; the same applies in the case of smaller maximum yaw rates in the time interval 27 immediately before the zero pass of yaw rate. In other embodiment examples, the measure taken at time 26 can also be completely omitted, for example if, in the time interval 27, the value of yaw rate 22 has not exceeded at least a threshold value 36, where this threshold value itself can be a function of the vehicle speed and/or other magnitudes of relevance to the dynamics of movement.

In the case of extreme steering maneuvers with higher dynamics, the concept which is represented here also provides for changing, if needed, the shock absorber control in a close temporal sequence, to confer the optimally adapted steering characteristic to the vehicle in each time interval.

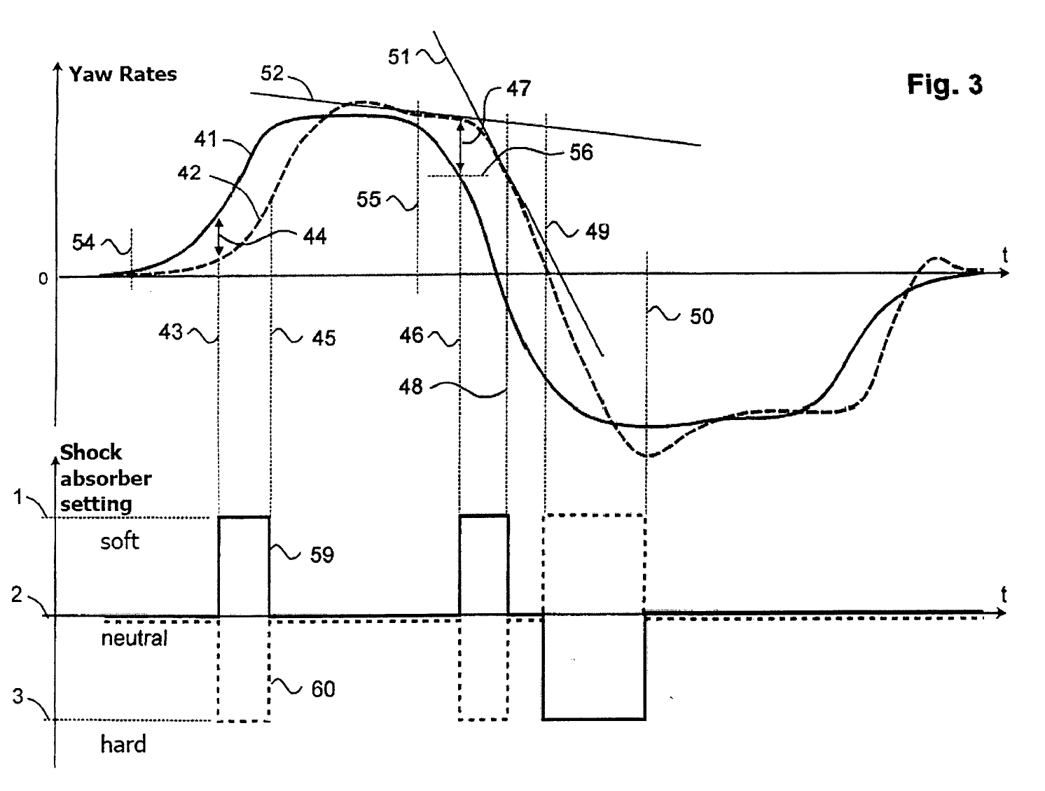

On this topic, FIG. 3 again shows a driving situation similar to that of FIG. 1 and FIG. 2, where the driver here at time 54 steers very hard into the left curve and time 55 also countersteers very dynamically into a left curve. As a result of the fact that, at time 55, that is in the left curve, the vehicle has not yet stabilized, the subsequent behavior during the countersteering in 55 is poor, which is indicated by the fast the vehicle yaw rate 42 follows rapidly after the reference yaw rate 41. The driver may consider this phase delay in the vehicle's reaction to be dangerous, if, as a result of the driving situation, he/she must stay within a narrow path and then overreact by applying an excessively high curve angle in the opposite direction. In many cases, this leads to strong and excessively long steering resulting in vehicle instability. Therefore, it is important to give the driver as direct as possible a vehicle reaction.

According to the concept of shock absorber steering which is presented here, the steerability of the vehicle is therefore increased at time 46, when the difference 47 between the vehicle yaw rate 42 and the reference yaw rate 41 exceeds a threshold. For this purpose, the shock absorbers of the front axle (curve path 61 at time 46 is switched from the neutral state 62 into the soft state 61, while the rear axle shock absorber (curve course 60) is changed from the neutral state 62 into the hard state 63. At time 48, one notes that the vehicle reacts sufficiently and has built up a gear rate gradient 51 of high value in the direction of the right curve. Therefore, at time 58, all the shock absorbers are changed to the neutral state 62. Subsequently, the vehicle yaw rate 42, at time 49, intersects the zero line, and the measure which has already been represented in FIG. 2 is applied, which again confers to the vehicle an understeering characteristic. As a result, even during highly dynamic countersteering, the yaw rate increase at time 50 is damped.

In additional embodiment examples according to the invention, the prophylactic measure at time 49 is not only activated at the time of the zero pass of the yaw rate, but already when the gradient of the vehicle yaw rate reaches or exceeds the reference yaw rate. In such cases, the vehicle already has build up sufficient, and even excessively high, dynamics in the new curve direction, which requires the yaw rate damping.

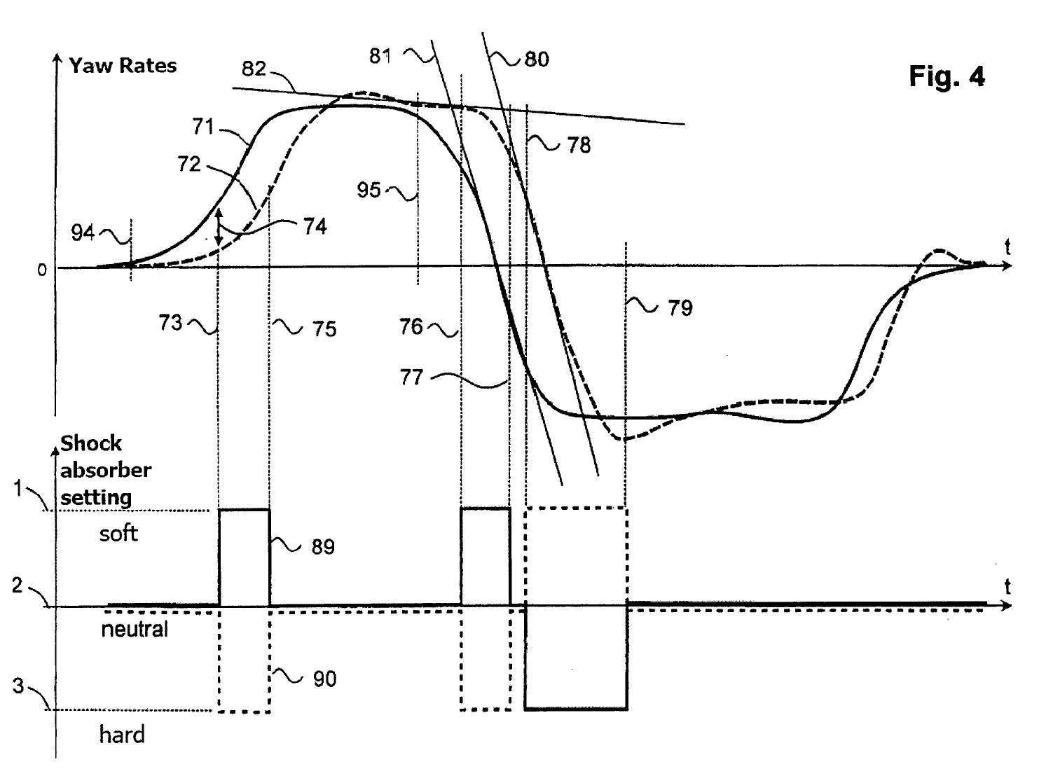

FIG. 4 shows such an example.

Here the intervention of the shock absorber position which results in understeering is started already at time 78, when the yaw rate has not yet intersected the zero point. However, the amount of the gradient 80 of the vehicle yaw rate 72, exceeds the amount of the gradient 81 of the reference yaw rate 71. The preferred shock absorber control, even if the driver steers abruptly (indicated in FIG. 4) ensures a good damping of the yaw rate increase (time 79).

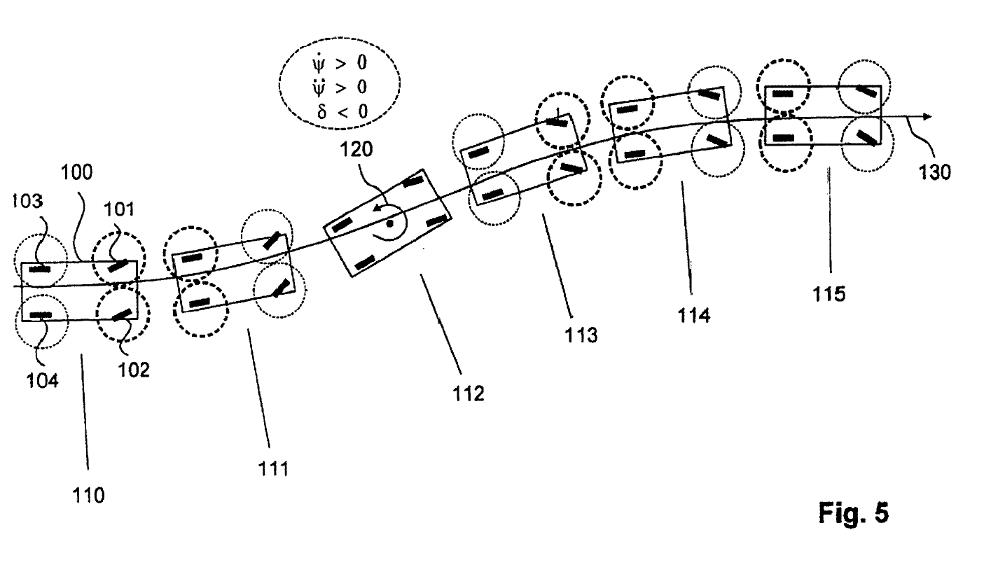

FIG. 5 shows the result of a change from a left to a right curve of a stylized vehicle 100 with the front wheels 101 and 102 (front wheels=steering wheels, steering angle indicated by the position of the wheels) as well as the back wheels 103 and 104 in temporally and spatially successive phases 110 to 115.

During the maneuver, the driver seeks to follow the course sketched by line 130 in the direction of the arrow.

The circles, drawn in thin lines or thick broken lines around the wheels, represent the shock absorber control in the individual phases.

A thin circle means that the shock absorber has switched the wheel concerned to hard. A thick circle indicates a soft shock absorber characteristic. The shock absorber of a wheel without a circle is switched to neutral.

In the phase 110, the driver attempts to steer into the left curve and is supported in that process by an increase in the steerability of the vehicle. This is achieved by a soft shock absorber adjustment in the front and a hard adjustment in the back. In phase 111, the vehicle has built up a sufficiently high yaw rate, and the gradient of the yaw rate \dot{ψ}, that is the yaw acceleration \ddot{ψ}, exceeds the gradient \ddot{ψ}_{ref} of the reference yaw rate \dot{ψ}_{ref}. Now the vehicle is damped in its left turn by imparting an understeering behavior to it. This is achieved by a soft shock absorber adjustment in the back and a hard adjustment in the front.

In phase 112, the vehicle is still turning in the left direction (yaw rate 120), when the driver already has set a negative driving angle, but wants to start the left turn. Thus, there is both oversteering with respect to the left turn which is still in place, and also an understeering with respect to the required right turn. In this phase, the rear axle of the vehicle must first be stabilized so that it can reduce the left turn.

For this purpose, as a function of defined thresholds, an understeering or neutral vehicle behavior is forced by the shock. absorber adjustment. When the yaw rate \dot{ψ} no longer increases, that is when the gradient \ddot{ψ} is negative, a switch is made to an oversteering characteristic, so that the front axle can transfer an increased steering moment, and the vehicle can steer into the new right direction (phase 113). Because of the highly dynamic change in maneuver, one must then expect in phases 114 and 115 a high yaw rate \dot{ψ} in the right direction, so that the vehicle is then again imparted an understeering characteristic.

Additional embodiments of the invention, in the case of continuously adjustable shock absorbers, consist in that all the measures of the adaptive shock absorber steering do not occur purely digitally, but analogically between two switching steps “soft” or “hard.”

The analogous shock absorber values, for this purpose, are calculated as functions of the values relevant to the dynamics of movement, which are known from the ESP. These shock absorber values can be superposed over other control values, which are the result of additionally implemented control strategies, where the superposition is temporarily exclusive or proportional via mixing ratios.

FIG. 4 has shown that in highly dynamic driving situations, a rapid switching of the shock absorber characteristic is required. The switch involved in this strategy is made more difficult if slow reacting adjustment devices are used and/or if the demands for controlling the adjustment devices are sent over data bus systems. In all of the above measures, one includes in the calculation, according to the invention, the reaction time T_{T} which results from the transfer times as well as the delay time T_{V} of the adjustment shock absorbers, to prevent control in the counterphase from the point of view of control technology. For this purpose, the above-mentioned threshold requirements are implemented additionally as functions of T_{T} and T_{V}. In principle, the thresholds decrease with increasing total time T_{T}+T_{V} to move the decision concerning an adjustment measure to an earlier time. As a result, the time delay resulting from T_{T} and T_{V} is compensated at least in part.

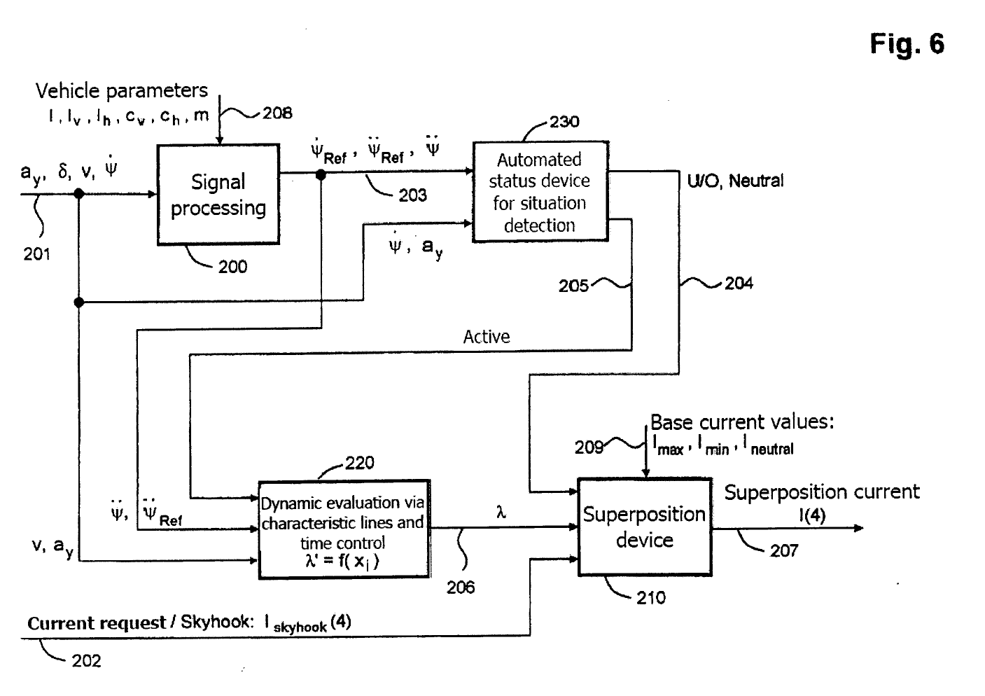

To represent the technical implementation of the above-mentioned control strategies, FIGS. 6 to 10 present an embodiment example according to the invention.

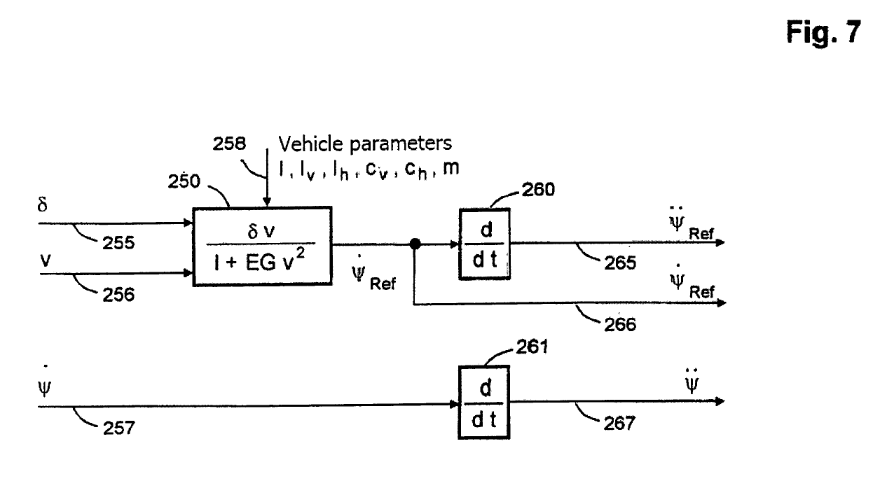

FIG. 6 is the block diagram of a device which, from the input signals which are delivered by the ESP to the line 201 with the help of the circuit 200 (see detailed diagram in FIG. 7), forms, as additional signals, the reference yaw rate \dot{ψ}_{ref}, its derivative \ddot{ψ}_{ref} as well as the derivative \ddot{ψ} of the measured yaw rate \dot{ψ}, and applies it to the line 203.

In addition, the device 200 also needs the vehicle specific parameters l, lᵥ, lₕ, cᵥ, cₕ, m on the line 208. Here l=wheel position, lᵥ and lₕ=stand for the distance of the rear axle and the front axle from the vehicle's center of gravity, c=coefficients for the resulting stiffnesses obtained from tire, wheel suspension and steering elasticity, m=mass and the indexes v=front, h=back.

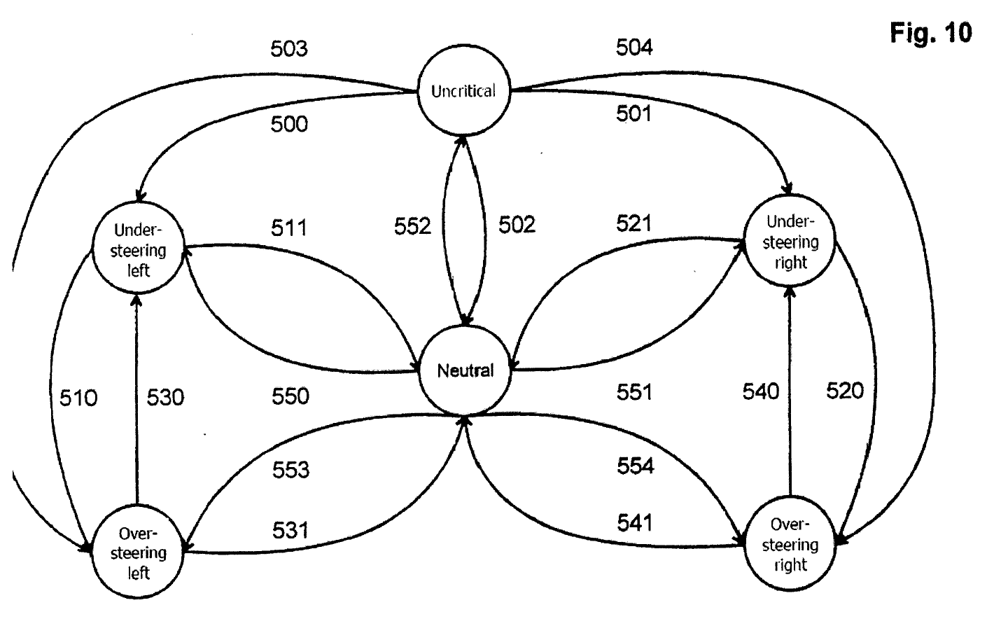

By means of a automated status device 230 (see detailed status diagram in FIG. 10), the signals \dot{ψ}_{ref}, \ddot{ψ}_{ref}, \dot{ψ}, \ddot{ψ}, a_{y} on the lines 201 and 203 are used for the purpose determining the given driving situation in each case. The active status (system wants to intervene with shock absorber control) is indicated by the active flag on line 205, on line 204 understeering or overdriving situations are distinguished with the flag U/O (Understeering/Oversteering) in the case of oversteering, the flag is 1, and in the case of oversteering it is 0. The neutral status is represented by the neutral flag, which becomes 0 in the case of oversteering or understeering, and which assumes the value 1 in the case of a neutral steering behavior.

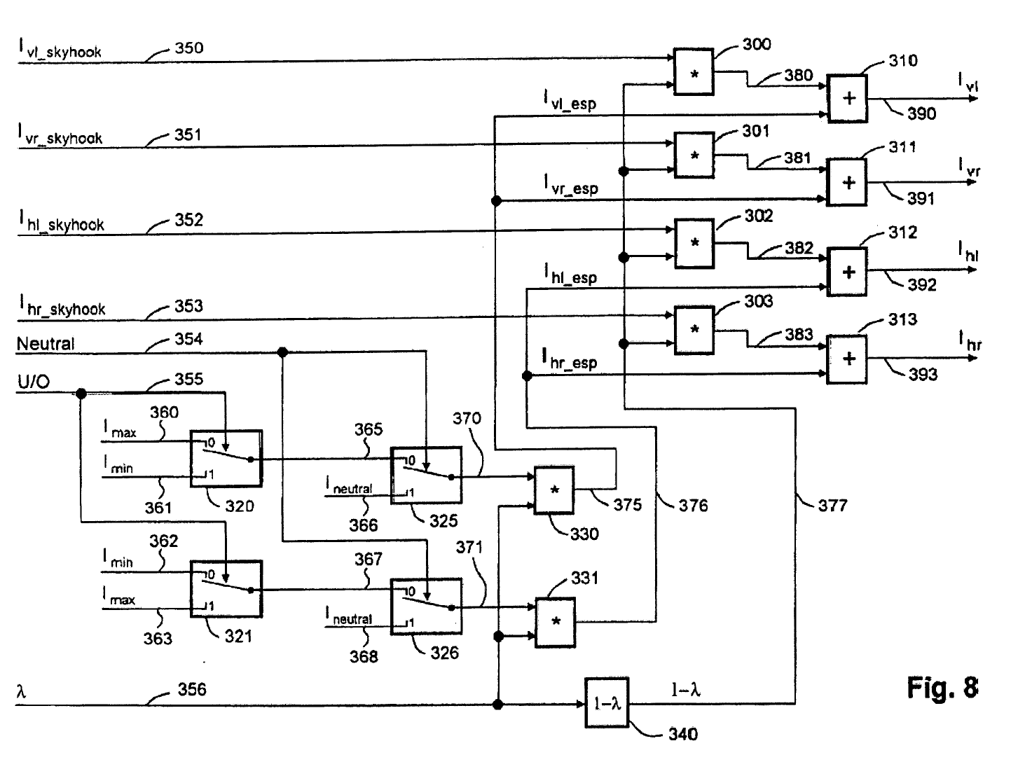

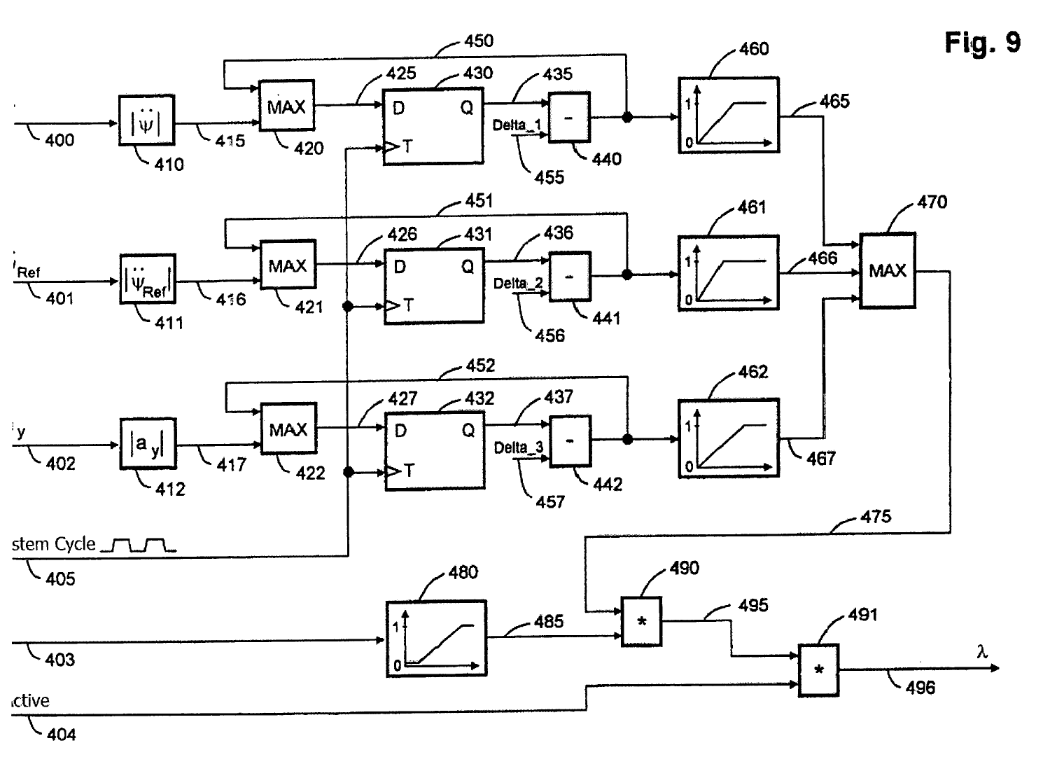

Using characteristic lines and temporal control in the block 220 (see detailed diagram in FIG. 9), and using the steering dynamically relevant input magnitudes on the lines 201 and 203 as well as the active flag on line 205, a determination is made how critical the present case is from the point of view of dynamics of movement. From the overall consideration, one gets a factor λ, which can assume values from 0 (completely uncritical) to 1 (very critical). In the present embodiment example, the factor of λ indicates a mixing ratio for an analogous optimized shock absorber control, from the point of view of dynamics of movement, which in part is superposed over the basic principle of the skyhook control. Therefore, λ is sent through the line 206 to the superposition device 210 (see detailed diagram in FIG. 8), which is calculated from λ, the steering information on line 204 as well as the basic current values Iₘₐₓ,Iₘᵢₙ,Iₙₑᵤₜᵣₐₗ online 209 for all 4 wheel circles, which are appropriate from the point of view of the ESP system and the control. The latter are then superposed, for each wheel, over the 4 current values on line 202, which can be the result of a skyhook control which is not an object of this application. The 4 total current values I(4) then, via line 207, reach the 4 shock absorbers of the wheels and they are converted there, for example, by appropriate driving circuits into physical currents.

FIG. 7 represents the formation of the required signals (embodiment of block 200 of FIG. 6).

From the steering angle on line 255, the estimated vehicle longitudinal speed on line 256 as well as several vehicle specific parameters on line 258, from which the specific steering gradient EG can be calculated, one gets, using the formula in block 250, the reference yaw rate on line 266, from which the reference yaw acceleration on line 265 is then calculated using a differentiation element 260. The vehicle parameters on line 258 can be fixed for a certain vehicle or they can be evaluated dynamically by the ESP during the operation.

Using an additional differentiation element 261 the measured vehicle yaw rate on line 257 is used to also determine the actual yaw acceleration on line 267.

FIG. 8 shows an embodiment example of the superposition device 210 from FIG. 6.

Using the switches 320, 325 (for the front wheels) and 321 and 326 (for the back wheels), the signals “U/O” (1 for understeering, 0 for oversteering, on line 355 and “neutral” on line 354 are evaluated to select appropriate basic current values for the shock absorbers of the 4 wheels as function of the vehicle status which is determined in the automated device 230 in FIG. 6.

These basic current values produce the desired shock absorber characteristic, where a maximum current Iₘₐₓ (on line 360 for the front wheels, on line 363 for the back wheels) must switch the appropriate shock absorber to hard, a medium current Iₙₑᵤₜᵣₐₗ (on line 366 for the front wheels, on line 368 for the back wheels) must switch the appropriate shock absorber to neutral, and a minimum current Iₘᵢₙ (on line 361 for the front wheels, on line 362 for the back wheels) must switch the appropriate shock absorber to soft.

The basic current values selected by “U/C” and “neutral” then reach the lines 370 (for the front wheels) and 371 (for the back wheels)and they are multiplied with the factor λ which is delivered by line 356, by means of the blocks 330 and 331. On the lines 375 and 376, the current values Iᵥₗ_{_{—}}ₑₛₚ, Iᵥᵣ_{_{—}}ₑₛₚ and Iₕₗ_{_{—}}ₑₛₚ, Iₕᵣ_{_{—}}ₑₛₚ, respectively, which are required in each case for the front and back wheels, then appear.

The block 340 applies the value ‘1-λ’ to line 377, with which the 4 current values required by the skyhook controller on lines 350 to 353 are then multiplied via the blocks 300 to 303 for each individual wheel. The results represent the current portions of the skyhook controller and they reach the lines 380 to 383. Then, using the addition elements 310 to 313, the ESP and skyhook current portions are superposed by addition and they are sent via the output lines 390 to 393 to the shock absorbers.

In this manner, in uncritical cases (λ[=]0 or <<1), almost only the skyhook portion is converted, and thus a comfortable road performance is achieved. In critical cases (λ=1 or almost 1) the ESP portion predominates and it allows the driver to experience good handling with a reduced damping comfort.

FIG. 9 shows an embodiment example for the calculation of the mixing factor λ, that is of the block 220 from FIG. 6. For this purpose, the maximum values of several values of relevance to the dynamics of movement from the ESP are applied via the lines 400 to 402. Via the blocks 420 to 422, the amounts of the signals are formed, and applied via the lines 415 to 417 to the blocks 420 to 422, which form a maximum formation between the actual values on 415 to 417 and the stored earlier maximum values on lines 450 to 452. The new maxima are switched to the lines 425 to 427, and they are transferred, using the system cycle to line 405 at defined times (with the positive flank of the cycle), into the associated memory cells 430 to 432. The stored maximum values then appear on the output lines 435 to 437. To implement a forgetting function, these values are reduced, using the subtraction elements 440 to 442, by the small delta amounts on the lines 455 to 457. The results again appear on the lines 450 to 452, and they are again compared with the actual amounts of the signals of relevance to the dynamics of movement (400 to 401). As long as the input signals 400 to 402 increase, they are stored in the memory cells 430 to 432. In the case of small input signals, the large stored values are reduced, at each system cycle, by the delta values 455 to 457. In this manner, the occurrence of a high dynamics of movement is forgotten after a defined time period, because such events are also relevant only within a certain time sequence. The current movement dynamics values for 450 to 452 are classified, via evaluation functions 460 to 462, to values from 0 to 1, and the latter are then applied via the lines 465 to 467 to the lock 470, which switches the maximum of the values to line 475.

Because the evaluated signals 400 to 402 are of relevance only at higher speeds, an additional evaluation of the situation by the block 480, occurs, which also converts the estimated longitudinal speed signal delivered on line 403 to a value from 0 to 1, which is multiplied on line 485 using the block 490. The result on line 495 is then multiplied with the active signal on line 404 (which comes from block 230 in FIG. 6) via the block 491. The result on line 496 represents the factor λ.

Driving Situation Detection:

The control strategy for the phase-accurate shock absorber control contains the block 230 in FIG. 6 and it is described as an automated status device in FIG. 10.

Below, a driving situation detection is explained, by means of which the behavior of continuously adjustable shock absorbers can be adjusted and, as a result, influence the road behavior of the vehicle.

If the front axle shock absorbers are switched to soft and the rear axle shock absorbers to hard, then the rear axle is destabilized during dynamic maneuvers, which means that the lateral force support on the rear axle is smaller than on the front axle. The vehicle tends to exhibit oversteering, and the steerability is supported.

The behaviors are opposite, when the front axle shock absorber is switched to hard and the rear axle shock absorber to soft. The vehicle tends to exhibit oversteering, and the stabilization of the vehicle is supported.

FIG. 10, using a status graph, represents the sequence of steering activities according to the invention. The vehicle is first in the status “uncritical,” which is characterized in that the following conditions are satisfied:
|\dot{ψ}_{ref}−\dot{ψ}|<ε₁ and |\ddot{ψ}_{ref}−\ddot{ψ}|<ε₂ and |a_{y}|<ε₄

In this status, the comfort control of the shock absorbers remains activated (only in this status) and, no adjustments on the shock absorbers are required by the ESP.

If the driver of the vehicle engages into a curve in a nearly static manner, and the transverse acceleration exceeds a predetermined threshold value, there is a switch to the status “neutral.”
|\dot{ψ}_{ref}−\dot{ψ}|<ε₁ and |\ddot{ψ}_{ref}−\ddot{ψ}|<ε₂ and |a_{y}|>ε₄ (502)

The shock absorbers are switched to neutral, and thus the comfort control of the shock absorbers is deactivated.

If, because of decreasing transverse acceleration, one changes from the status “neutral” to the status “uncritical,” the gradient of the vehicle yaw rate \ddot{ψ} can be greater than the gradient of the reference yaw rate \ddot{ψ}_{ref} if the steering instruction is changed to the opposite direction. If the condition
\ddot{ψ}_{ref}≦\ddot{ψ} and \ddot{ψ}>ε₃ (503)
is satisfied, there is a switch to the status “oversteering in the left curve.”

The shock absorbers are switched in such a manner that the stabilization of the vehicle is supported.

In contrast, if the condition
\ddot{ψ}_{ref}≧\ddot{ψ} and \ddot{ψ}<−ε₃ (504)
is satisfied, one switches to the status “oversteering in the right curve.”

The shock absorbers are switched in such a manner that the stabilization of the vehicle is supported.

In the status “neutral,” and if condition (552) is satisfied, that is the transverse acceleration drops below a minimum value
|\dot{ψ}_{ref}−\dot{ψ}|<ε₁ and |\ddot{ψ}_{ref}−\ddot{ψ}|<ε₂ and |a_{y}|<ε₅ (552)
then one switches again to the status “uncritical.”

As a result of the different thresholds ε₄ and ε₅, an unnecessary switching back and forth between the status “uncritical” and the status “neutral” is avoided.

The comfort control of the shock absorber can then be activated again.

If the vehicle is able to follow the desired course satisfactorily, and if the transverse acceleration has not yet been reduced, then one is in the status “neutral.” Because of a new steering instruction in the opposite direction of the previous direction, then with the condition
\ddot{ψ}_{ref}≦\ddot{ψ}and \ddot{ψ}>ε₃ (553)
one reaches the status “oversteering in the left curve,” and, on the other hand, with the condition
\ddot{ψ}_{ref}≦\ddot{ψ} and \ddot{ψ}<−ε₃ (554)
on reaches the status “oversteering in the right curve.”

The shock absorbers in each case are switched in such a manner that the stabilization of the vehicle is supported.

If the driver forms a steering maneuver, in which the vehicle is no longer able to follow the indicated reference behavior, that is if the following conditions are satisfied:
\dot{ψ}_{ref}>\dot{ψ}+ε₁ and \ddot{ψ}_{ref}>\ddot{ψ}+ε₂ (500)
one switches to the status “understeering in the left curve.” An oversteering signal is sent to the shock absorbers to support the steerability.

If the steering behavior is maintained, the gradients of the yaw rate first diverge, because the vehicle presents inertia in its behavior. However, after a certain time period, the vehicle is able to follow the request, or a new steering direction is indicated. The condition that the gradient of the vehicle yaw rate \ddot{ψ} is greater than the gradient of the reference yaw rate \ddot{ψ}_{ref} (510) is satisfied. One recognizes oversteering in the left curve if
\ddot{ψ}_{ref}≦\ddot{ψ} (510)
is satisfied.

The shock absorbers are switched in such a manner that the stabilization of the vehicle is supported.

However, if the gradient of the reference yaw rate \ddot{ψ}_{ref} again becomes greater than the gradient of the vehicle yaw rate \ddot{ψ}, then there is understeering in the left curve (530).

The shock absorbers are switched in such a manner that the steerability is supported.
\ddot{ψ}_{ref}>\ddot{ψ} (530)

However, if the vehicle is still in the status “understeering in the left curve,” the shock absorbers are switched in such a manner that the stabilization is supported.

If the gradient of the vehicle yaw rate \ddot{ψ} decreases, and the following condition is satisfied,
\ddot{ψ}≦ε₃ (531)
then there is a switch to the status “neutral.” Here one waits until the vehicle reacts.

The shock absorbers are switched to neutral, so that oversteering/understeering is not promoted.

However, in the case where the reference yaw rate \dot{ψ}_{ref} is again greater than the vehicle yaw rate \dot{ψ}, that is if the steering was again in the same direction (left) and the condition
\dot{ψ}_{ref}>\dot{ψ}+ε₁ and \ddot{ψ}_{ref}>\ddot{ψ}+ε₂ (550)
is satisfied, then the status “understeering in the left curve” occurs.

If the vehicle is still in the status “neutral” and if the yaw rates and the gradients of the yaw rates differ from each other in such a manner that the condition (551) is satisfied,
\dot{ψ}_{ref}<\dot{ψ}−ε₁ and \ddot{ψ}_{ref}<\ddot{ψ}−ε₂ (551)
then the vehicle switches to the status “understeering in the right curve.”

The shock absorbers are switched in such a manner that the steerability is supported.

If the steering instruction is maintained, the gradients of the yaw rates diverge, because the vehicle presents inertia in its behavior. However, after a certain time period, the vehicle will be able to follow the request, or a new steering direction is applied. The condition that the gradient of the vehicle yaw rate \ddot{ψ} becomes smaller than the gradient of the reference yaw rate \ddot{ψ}_{ref} (520) is satisfied. Oversteering in the right curve is recognized.
\ddot{ψ}_{ref}≦\ddot{ψ} (520)

The shock absorbers are switched in such a manner that the vehicle is stabilized.

However, if the gradient of the reference yaw rate \ddot{ψ}_{ref} becomes smaller than the gradient of the vehicle yaw rate \ddot{ψ}, then oversteering in the right curve occurs again (540).
\ddot{ψ}_{ref}<\ddot{ψ} (540)

The shock absorbers are switched in such a manner that the steerability is supported.

However, if the vehicle is still in the status “oversteering in the right curve,” then the shock absorbers are switched in such a manner that the stabilization is supported.

If the gradient of the vehicle yaw rate \ddot{ψ} decreases, the following condition is satisfied,
−ε₃≦\ddot{ψ} (541)
then there is a switch to the status “neutral.” Here one waits for the reaction of the vehicle.

The shock absorbers are switched to neutral, so that oversteering/understeering is not promoted.

From the status “neutral,” via the condition (550), one reaches the steering status “understeering in the left curve” or, via condition (551) one reaches the driving status “understeering in the right curve.”

If the status “understeering in the left curve” occurs, there is hardly any difference between the yaw rates and the gradients of the yaw rates (511)
|\dot{ψ}_{ref}−\dot{ψ}|<ε₁ and |\ddot{ψ}_{ref}−\ddot{ψ}<ε₂ (511)
then one changes again to the status “neutral.”

If the status “understeering in the right curve” occurs, there is hardly any difference between the yaw rates and the gradients of the yaw rates (521)
|\dot{ψ}_{ref}−\dot{ψ}|<ε₁ and |\ddot{ψ}_{ref}−\ddot{ψ}<ε₂ (521)
then one changes again to the status “neutral.”

For the shock absorbers to be controlled in accordance with the described strategy, then, in each status, there is a setting or setting back of the control flag “U/O,” “neutral” and “active” as shown below:

Status ‘Uncritical’:
U/O=0 or 1
Neutral=0 or 1
Active=0

Status ‘Neutral’:
U/O=0 or 1
Neutral=1
Active=1

Status ‘Understeering Left’:
U/O=1
Neutral=0
Active=1

Status ‘Understeering Right’:
U/O=1
Neutral=0
Active=1

Status ‘Oversteering Left’:
U/O=0
Neutral=0
Active=1

Status ‘Oversteering Right’:
U/O=0
Neutral=0
Active=1

1-32. (canceled)

33. A method for the control of digitally and analogically adjustable shock absorbers, where the shock absorbers are controlled according to the situation by means of a control signal such that the road performance of the vehicle is improved when understeering or oversteering occurs, comprising the steps of
determining phase magnitudes,
calculating the phases of the control signals from the phase magnitudes, and,
in the case of a driving situation with a tendency to sway, determining a moment in time as a function of at least the magnitudes which describe the rotation of the vehicle about the vertical axis, when a correct phase control of the shock absorbers of the vehicle is carried out to increase the steerability when understeering occurs and to increase the driving stability when oversteering occurs.

34. The method according to claim 33, wherein a correct phase control occurs as a function of the yaw rate and at least one derivative of the yaw rate.

35. The method according to claim 33, additonally including the steps of
determining a reference yaw rate based on a model calculation;
measuring the actual yaw rate of the vehicle;
determing the difference between the reference yaw rate and the measured yaw rate;
determining the difference between the gradients of the two yaw rates, i.e. between the reference yaw acceleration and the actual yaw acceleration of the vehicle, and
determining, from the differences of the yaw-related quantities, accurate phase switching moments in time, between which the shock absorbers of the wheels can be adjusted.

36. The method according to claim 35, wherein the reference yaw rate is determined in a linear single-track model.

37. The method according to claim 33, wherein the control concept is a part of an ESP control strategy, and signals from the ESP control are processed for carrying out the method.

38. The method according to claim 33, wherein an understeering behavior in the left curve is recognized if the condition \dot{ψ}_{ref}>\dot{ψ}+ε₁ and \ddot{ψ}_{ref}>\ddot{ψ}ε₂ is satisfied, and wherein an understeering behavior in the right curve is recognized if the condition \dot{ψ}_{ref}<\dot{ψ}−ε₁ and \ddot{ψ}_{ref}<\ddot{ψ}−ε₂ is satisfied, and wherein, if an understeering behavior is recognized in any of the two directions, the shock absorbers of the fronts wheels are softened and those of the back wheels are hardened to incraase steerability.

39. The method according to claim 33, wherein an oversteering behavior in left curve is recognized if the condition \ddot{ψ}_{ref}≦\ddot{ψ} and \ddot{ψ}>ε₃ is satisfied, and wherein an oversteering behavior in right curve is recognized if the condition \ddot{ψ}_{ref}≧\ddot{ψ} and \ddot{ψ}<−ε₃ is satisfied, and wherein, if an oversteering behavior is recognized in any of the two directions, the shock absorbers of the front wheels are hardened and those of the back wheels are softened to increase stability.

40. The method according to claim 33, wherein a neutral behavior of the vehicle is recognized in any of the following instances:
after an understeering behavior occurred, the condition |\dot{ψ}_{ref}−\dot{ψ}|<ε₁ and |\ddot{ψ}_{ref}−\ddot{ψ}|<ε₂ is satisfied,
after oversteering occurred, the condition −ε₃≦\ddot{ψ}≦ε₃ is satisfied,
after the occurrence of an uncritical behavior, the condition |\dot{ψ}_{ref}−\dot{ψ}|<ε₁ and |\ddot{ψ}_{ref}−\ddot{ψ}|<ε₂ and |a_{y}|>ε₄ is satisfied;
and wherein, if a neutral behavior is recognized, the shock absorbers of the front wheels and the back wheels are all switched to medium to high damping.

41. The method according to claim 33, wherein an uncritical road performance is recognized after the occurrence of a neutral behavior, because the condition |\dot{ψ}_{ref}−\dot{ψ}|<ε₁ and |\ddot{ψ}_{ref}−\ddot{ψ}|<ε₂ and |a_{y}|<ε₅ is satisfied, and wherein, if an uncritical behavior is recognized, the shock absorbers are again switched to the state which corresponds to the standard control strategy used.

42. The method according to claim 33, wherein the stiffness of the shock absorbers is adjusted continuously, where the amount of damping depends on the prevalent driving situation.

43. The method according to claim 33, wherein the stiffness of the shock absorbers is adjusted and depends on the dynamics of the given driving situation, and wherein the dynamics of movement is evaluated considering at least one member of the group consisting of the following quantities:
the actual yaw rate of the vehicle, the actual yaw acceleration of the vehicle, the reference yaw rate, the reference yaw acceleration, and the lateral acceleration of the vehicle.

44. The method according to claim 43, wherein the quantities considered for the evaluation of the dynamics of movement are weighted using the longitudinal speed of the vehicle.

45. The method according to claim 43, wherein for the evaluation of the dynamics of movement not only the currently measured or calculated dynamics of movement signals at a certain time is considered, but also the course of these signals within a past time interval . . . delta_T . . . , where the maximum values of the signals are stored and they are unlearned over the course of time by linear or degressive reduction.

46. The method according to claim 33, wherein the control of the shock absorbers with the phase-correct control signal is superposed by addition over the requirements of additional shock absorber control mechanisms.

47. The method according to claim 46, wherein the amount of the additive superposition of different requirements for the shock absorbers is established by the reached amount of the dynamics of movement and, in the case of high dynamics of movement, a high proportion of up to 100% is requested, while, in the case of lower dynamics of movement, only a small portion of as little as 0% is requested and superposed over a correspondingly large portion of an additional control strategy.

48. The method according to claim 33, wherein thresholds ε are adapted, for the determination of the driving situation, to reaction times due to the data transfer between the controller and the shock absorbers, and the delay times are adapted to the shock absorbers, where, in the case of a larger sum of reaction time and delay time, smaller thresholds are used so that the switching reaction occurs on time.

49. A device for the control of digitally or analogically adjustable shock absorbers, where the shock absorbers are controlled according to the situation in such a manner that the road performance of the vehicle is improved when understeering or oversteering occurs, comprising a determination unit (200) for the determination of phase magnitudes, for which the phases of the control signals are calculated, an additional determination unit (230) for the determination of a driving situation with a tendency to sway and a regulation and control unit (220, 210), and which device, as a function of at least the magnitudes, describes the rotation of the vehicle about the vertical axis and determines a moment in time at which a correct phase control of the shock absorbers of the vehicle is carried out to increase the steerability when understeering occurs and the driving stability when oversteering occurs.

50. The device according to claim 49, wherein the determination unit (200) determines the deviation between the reference yaw rate which has been determined according to a linear single-track model and the actually measured yaw rate of the vehicle as well as the difference between the gradients of the two yaw rates, that is the reference yaw acceleration and the actual yaw acceleration of the vehicle, and wherein the control unit (220, 210), with inclusion of the determination unit (230), determines phase-accurate switching moments in time from the yaw magnitudes, between which moments in time the shock absorbers of the wheels are switched to hard or soft in steps or continuously.

51. The device according to claim 49, wherein the control concept is part of an ESP control strategy and includes the signals of the ESP control in the control and/or control of the shock absorbers.

52. The device according to claim 49, wherein the determination unit (230) recognizes an understeering behavior in the left curve if the condition \dot{ψ}_{ref}>\dot{ψ}+ε₁ and \ddot{ψ}_{ref}>\ddot{ψ}+ε₂ is satisfied, and an understeering behavior in the right curve if the condition \dot{ψ}_{ref}<\dot{ψ}−ε₁ and \ddot{ψ}_{ref}<\ddot{ψ}−ε₂, and wherein, if understeering behavior is recognized in any of the two directions, the determination unit (230) generates a signal which is used to switch the shock absorbers of the front wheels to soft and those of the back wheels to hard.

53. The device according to claim 49, wherein the determination unit (230) recognizes an oversteering behavior in a left curve if the condition \ddot{ψ}_{ref}≦\ddot{ψ} und \ddot{ψ}>ε₃ is satisfied, and an oversteering behavior in a right curve if the condition \ddot{ψ}_{ref}≦\ddot{ψ} and \ddot{ψ}<−ε₃ is satisfied, and wherein, if oversteering behavior is recognized in any of the two directions, the determination unit (230) generates a signal which is used to switch the shock absorbers of the front wheels to hard and those of the back wheels to soft.

54. The device according to claims 49, wherein the determination unit (230) recognizes a neutral behavior of the vehicle if, after the occurrence of an understeering behavior, the condition |\dot{ψ}_{ref}−\dot{ψ}|<ε₁ und |\ddot{ψ}_{ref}−\ddot{ψ}|>ε₂ is satisfied, or if, after the occurrence of an oversteering behavior, the condition −ε₃≦\ddot{ψ}≦ε₃ is satisfied, or if, after the occurrence of an uncritical behavior, the conditions |\dot{ψ}_{ref}−\dot{ψ}|<ε₁ and |\ddot{ψ}_{ref}−\ddot{ψ}|<ε₂ and |a_{y}|>ε₄ are satisfied, and wherein, if neutral behavior is recognized, the determination unit (230) generates a signal which is used to switch the shock absorbers of the front wheels and back wheels equally to medium to high damping.

55. The device according to claim 49, wherein the determination unit (230) recognizes an uncritical road performance after the occurrence of a neutral behavior if the condition |\dot{ψ}_{ref}−\dot{ψ}|<ε₁ and |\ddot{ψ}_{ref}−\ddot{ψ}|<ε₂ and |a_{y}|<ε₄ are satisfied, and wherein, if uncritical behavior is recognized, the determination unit generates a signal which is used to switch the shock absorbers back to the state which corresponds to a standard control strategy used.

56. The device according to claim 49, wherein the control unit (220, 210) does not adjust the damping of the shock absorbers only in the discreet steps soft, medium, hard, but continuously, where the amount of damping depends on the given driving situation.

57. The device according to claim 49, wherein the control unit (220, 210) determines the amount of the continuously adjusted damping from the dynamics of the given driving situation, where, as relevant signals for the evaluation of the dynamics of movement, at least one of the members of the group consisting of the following quantities is considered:
The actual yaw rate, the actual yaw acceleration of the vehicle, the reference yaw rate the reference yaw acceleration, the lateral acceleration of the vehicle.

58. The device according to claim 49, wherein the values of the signals which are used for the evaluation of the dynamics of movement are weighted by means of the longitudinal speed of the vehicle.

59. The device according to claim 49, wherein, for the evaluation of the dynamics of movement, one uses not only the currently measured or calculated dynamics of movement signals at a moment in time, but also the course of the signals within a past time interval . . . delta_T . . . , where the maximum values of the signals are stored and they are unlearned by linear or degressive reduction over time.

60. The device according to claim 49, wherein the control of the shock absorbers is superposed additively over the requirements of other shock absorber control mechanisms.

61. The device according to claim 60, wherein the amount of the additive superposition of different requirements for the shock absorbers is determined by the reached amount of the dynamics of movement, and wherein, in the case of high dynamics of movement, a high proportion of up to 100% is requested, while, in the case of lower dynamics of movement, only a small proportion as low as 0% is requested and superposed over an accordingly high proportion of another control strategy.

62. The device according to claim 49, wherein for the determination of the road situation threasholds are sset and adapted to reaction times due to data transfer between the controller and the shock absorbers as well as to the delay times of the adjustment elements, where smaller thresholds are used in the case of a larger sum of reaction time and delay time so that the switching reaction occurs on time.

63. A vehicular ESP controller comprising a device for the control of adjustable shock absorbers, where the shock absorbers are controlled according to the situation in such a manner that the road performance of the vehicle is improved when understeering or oversteering occurs, the device comprising a determination unit (200) for the determination of phase magnitudes, for which the phases of control signals are calculated, an additional determination unit (230) for the determination of a driving situation with a tendency to sway and a regulation and control unit (220, 210), and which device, as a function of at least the magnitudes, describes the rotation of the vehicle about the vertical axis and determines a moment in time at which a correct phase control of the shock absorbers of the vehicle is carried out to increase the steerability when understeering occurs and the driving stability when oversteering occurs.
